(19) United States
(12) Patent Application Publication
(10) Pub. No.: US 2019/0214891 A1
(43) Pub. Date: Jul. 11, 2019

(54) WIRE OUTLET NOZZLE ARRANGEMENT

(71) Applicant: Aumann Espelkamp GmbH, Espelkamp (DE)

(72) Inventor: Wolfgang Lüttge, Hameln (DE)

(73) Assignee: Aumann Espelkamp GmbH, Espelkamp (DE)

(21) Appl. No.: 16/218,050

(22) Filed: Dec. 12, 2018

(30) Foreign Application Priority Data
Jan. 11, 2018 (EP) 18151155.1

(51) Int. Cl. H02K 15/04; H02K 15/00; B65H 51/10

(52) U.S. Cl. CPC H02K 15/0478; B65H 2701/36; B65H 51/10; H02K 15/0081

(57) ABSTRACT

A wire outlet nozzle arrangement includes a plurality of wire outlet nozzles situated in parallel with one another. Each of the wire outlet nozzles guides a winding wire in a wire feed device, wherein the wire outlet nozzles include an outlet opening, through which the winding wire guided in the wire outlet nozzle exits the respective wire outlet nozzles. The wire outlet nozzles are mounted so as to be at least partially movable in a direction perpendicular to the wire feed direction.

### CROSS REFERENCE TO RELATED APPLICATIONS

This patent application claims priority on and the benefit of European Patent Application No. 18151155.1 having a filing date of 11 Jan. 2018.

### BACKGROUND OF THE INVENTION

### Technical Field

The invention relates to a wire outlet nozzle arrangement, including a plurality of wire outlet nozzles situated in parallel with one another, each of which guides a winding wire in a wire feed device, wherein the wire outlet nozzles include an outlet opening, through which the winding wire guided in the wire outlet nozzle exits the respective wire outlet nozzle.

### Prior Art

In winding methods, in particular in the production of wave windings, a winding wire or a plurality of parallel winding wires is fed from wire outlet nozzles to a body to be wound.

In the method described in EP 3 182 562, a plurality of winding wires is fed from a generic wire outlet nozzle arrangement to the rotating shaping core of a winding device. The wire located on the shaping core is grasped by means of grippers and moved in a transport direction and the shaping core rotated to produce the winding heads of the wave winding. In the process, a wave winding is produced on the shaping core, which is then transferred in a transport direction. The transport device rotates synchronously with the shaping core, so that the resultant wave winding may be continuously produced. With this device, it is possible to shape winding mats in any length with a relatively small shaping core.

Known winding devices of the aforementioned kind have, among other things, the disadvantage that on the shaping core the wires exiting the wire outlet nozzle arrangement can only be arranged equally spaced on the shaping core due to the geometry of the grippers used. Since the wave windings produced must be introduced in multiple layers, for example, into a laminated stator core once a winding mat is produced, this results in the disadvantage that winding mats with equidistantly spaced windings are more difficult to introduce into the laminated core, since the actual required winding spacings change from winding layer to winding layer, and thus, the introduction can only be accomplished by successive tensioning of the winding mat.

### BRIEF SUMMARY OF THE INVENTION

The object of the present invention, therefore, is to provide a wire outlet nozzle arrangement and a wave winding device for producing a wave winding that avoids the disadvantages described.

This object is achieved by a wire outlet nozzle arrangement, including a plurality of wire outlet nozzles situated in parallel with one another, each of which guides a winding wire in a wire feed device, wherein the wire outlet nozzles include an outlet opening, through which the winding wire guided in the wire outlet nozzle exits the respective wire outlet nozzle, characterized in that the wire outlet nozzles are mounted so as to be at least partially movable in a direction perpendicular to the wire feed direction and by a wave winding device including the wire outlet nozzle arrangement disclosed herein. Advantageous embodiments are found in the dependent claims.

A wireless outlet nozzle arrangement according to the invention includes a plurality of wire outlet nozzles situated in parallel with one another, each of which guides a winding wire in a wire feed direction. The wire outlet nozzles in this configuration each include an outlet opening, through which the winding wire guided in the wire outlet nozzle exits the respective wire outlet nozzle. In this case, the wire outlet nozzles are mounted so as to be at least partially moveable in a direction perpendicular to the wire feed direction.

The wire outlet nozzle arrangement according to the invention is able to alter the spacing between the wire outlet nozzles in the direction transverse to the wire feed direction. In this way, the spaces between the nozzles and, therefore, between the fed winding wires on the shaping core may be altered during the ongoing process. Thus, it is possible to produce a winding mat that includes windings, which continually maintain different spacings relative to one another within a winding mat.

In order for windings to be produced with the same spacing on the shaping core over a certain period of time during the production process, the spacing of the wire outlet nozzles relative to one another must be held constant over a certain period of time. According to one particular embodiment of the present invention, it is therefore provided that the wire outlet nozzle arrangement according to the invention includes a locking arrangement, which is designed to fix the wire outlet nozzles in one movement position and thus, the nozzles are set space apart from one another.

The wire outlet nozzle arrangement according to the invention is equally suitable for traditional round wires, i.e., wires having a circular cross section, as well as for flat wires. According to one particular embodiment of the present invention, the outlet openings of the wire outlet nozzles may have a rectangular cross section, in which case then the winding wire also has a rectangular cross section.

There are multiple possibilities for moving the wire outlet nozzles transverse to the wire feed direction. Thus, for example, each nozzle may be moved via a dedicated actuator. This embodiment is relatively complicated and relatively expensive due to the plurality of actuators required. According to one particularly preferred embodiment of the present invention, it is provided that the wire outlet nozzle arrangement includes at least one contour roller mounted so as to rotate about an axis perpendicular to the wire feed direction, wherein the contour roller comprises a plurality of recesses engaging—in particular, positively—with the outsides of the wire outlet nozzles. In this configuration, each nozzle is guided in such a recess, so that it is fixed on the sides of the recess and is dependent on the movement of the contour roller.

According to the invention, the aforementioned contour roller may be shaped in a particular manner. It is preferable in this case that the recesses are closed grooves encircling the at least one contour roller, each of which has a plane of extension defined by its respective direction of extension, wherein the angles of inclination of the planes of extension of the grooves defined by the perpendicular to the respective rotation axis of the contour roller are selected so that the angle of inclination of the grooves becomes greater from the center of the contour roller outward toward both ends of the contour roller.

Thus, the grooves are inclined more sharply outwardly than in the center of the contour roller. The result of this is that the wire outlet nozzles guided in the grooves are forcibly guided by the grooves when the contour roller is rotated. Due to this forced guidance and the different pitch angle of the contour roller relative to its rotation axis, the wire outlet nozzles situated in the grooves are shifted more or less strongly in a direction transverse to the wire feed direction, specifically, in that the wire outlet nozzles situated further outward are shifted more sharply and the wire outlet nozzles situated further inward are shifted less sharply. The pitch angles of the adjacent grooves in this case are preferably selected so that equal spacings invariably form between individual nozzles. It is particularly preferred that the grooves are shaped in such a way that the maximum or minimal spacing between the wire outlet nozzles may be adjusted after a half rotation of the contour roller.

To the extent a spacing of the nozzles is mentioned here, it is preferred that this spacing between each pair of adjacent nozzles is always constant. It is theoretically conceivable for the spacings of the nozzles to become continuously or unevenly greater or smaller, in particular in one direction.

It is preferably provided that the wire outlet nozzle arrangement according to the invention comprises a drive unit, which drives the contour rollers in a rotational manner. Such a drive unit may naturally be coupled to a machine control, for example, the machine control of a wave winding device, so that the spacing of each nozzle is adjusted by a control program.

In this case, it is preferably provided that the drive unit is designed to be self-locking, so that the control roller is lockable in any position. In this way, the spacing of the nozzles may, if desired, be held constant, if this is required by the process.

As previously mentioned, the invention also relates to a wave winding device, which includes a wire outlet nozzle arrangement described above.

### BRIEF DESCRIPTION OF THE DRAWINGS

The invention is explained in greater detail below with reference to the FIGS. 1-3.

FIG. 1 schematically shows a perspective representation of a wire outlet nozzle arrangement according to the invention,

FIG. 2 shows a sectional view through a wire outlet nozzle arrangement in a first position, and

FIG. 3 shows a sectional view through a wire outlet nozzle arrangement in a second position.

### DETAILED DESCRIPTION OF PREFERRED EMBODIMENTS

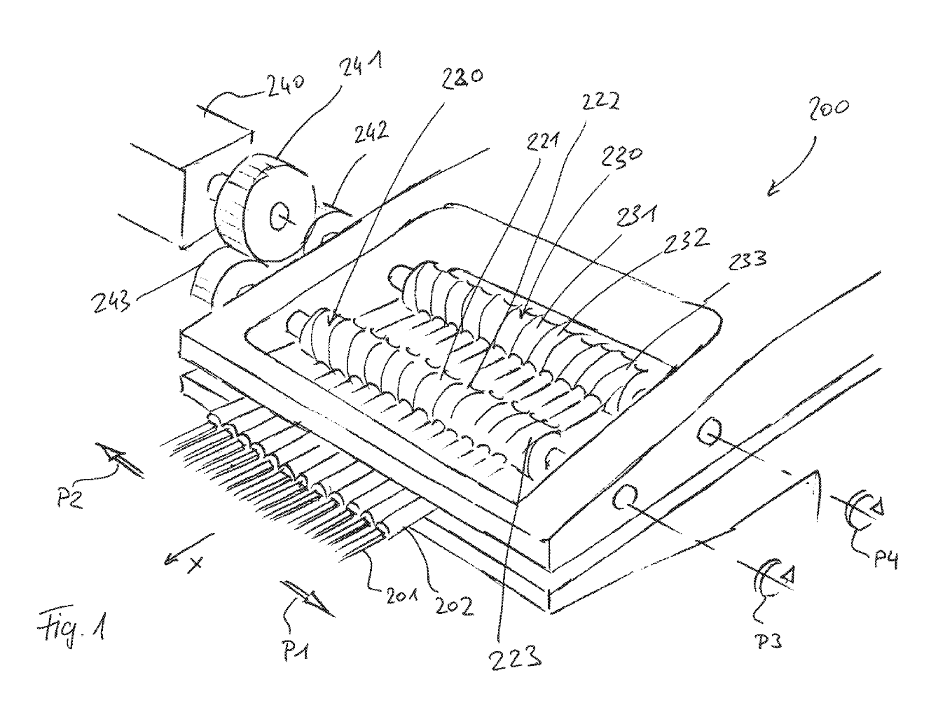

The wire outlet nozzle arrangement 200 shown in FIG. 1 includes a plurality of wire outlet nozzles 202, through which wires 201 are guided from the device 200 in a feed direction X and are guided, for example, to a shaping core of a wave winding device not shown, where the wires 201 are then wound to form a wave winding.

The arrangement 200 shown further includes a first contour roller 220 and an optional second contour roller 230 situated downstream thereof in feed direction X. It is sufficient for the functionality of the invention if the arrangement 200 includes a total of merely one contour roller. To synchronize the nozzles, the embodiment shown requires the use of two contour rollers 200, 230 spaced apart from one another, so that during a movement of the nozzles 202 relative to one another in the arrow direction P1, P2, the nozzles do not tip and assume an angle relative to feed direction X. Suitable other guide mechanisms that achieve the same may also be used. The contour roller 220 is rotatable about an axis P3, this takes place via a drive 240, which is connected in the example shown by a gear train 241, 243 to the shaft of the contour roller 220. The optional additional contour roller 230 is synchronized with the second contour roller 220 insofar as it is rotated on the same drive 240 via the gears 241, 242 about the axis P4.

As may be seen in FIGS. 1, 2 and 3, the contour rollers 220 and 230 include grooves or recesses 221-223 and 231-223, in which the wire outlet nozzles 202 are situated.

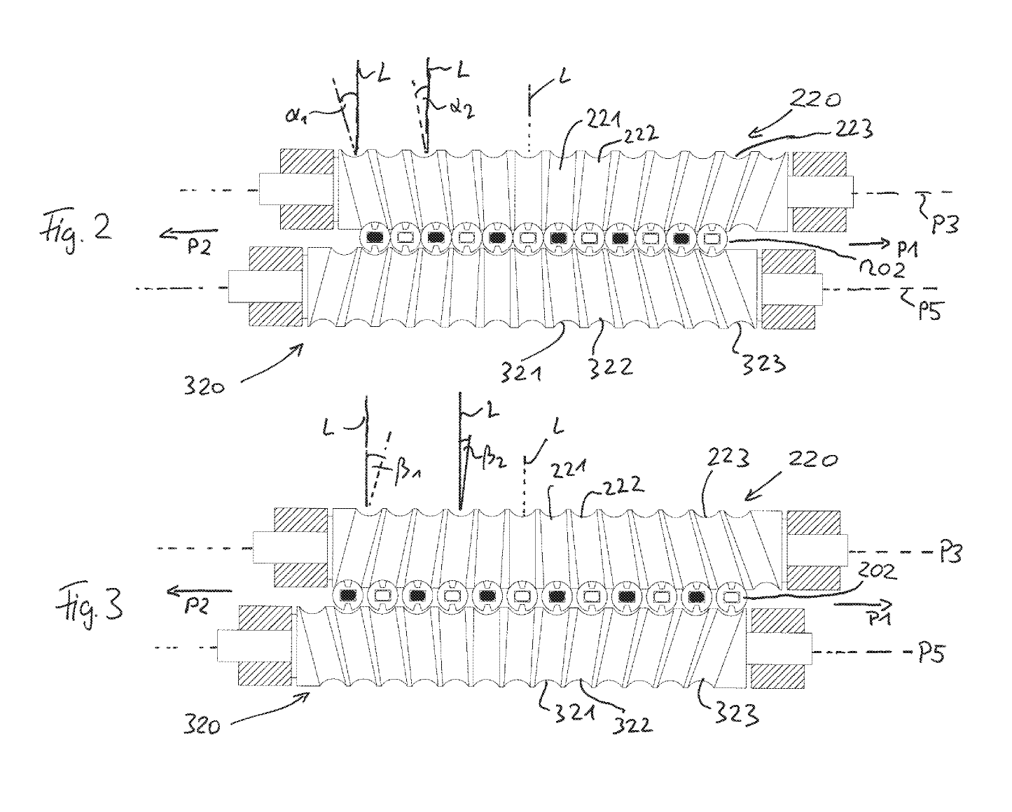

As is particularly apparent from FIGS. 2 and 3, in which an additional optional contour roller 320 is situated below the wire outlet nozzles 202, the grooves extend circumferentially around the respective contour roller 220, 320. However, the plane defined by the direction of extension of each groove differs from groove to groove. Like the contour roller 230 in FIG. 1, the contour roller 320 is also optional. Instead of the contour roller 230, a slide bearing, for example, could also be present, on which the nozzles glide along in arrow direction P1 or P2. The contour roller 220 may then also be situated above the nozzles (as in the example shown) or also below the nozzles 202, in this case, for example, a slide bearing may be located above the nozzles 202.

Whereas a middle groove of the contour rollers 230, 320 has a plane of extension, which extends parallel to the direction L perpendicular to the rotation axes P3 and P5, these planes of extension are increasingly tipped, the further outward on the respective contour roller 220, 320, the corresponding groove 221, 222, respectively, 223 or 321, 22, respectively, 323 is located. This is indicated in FIG. 2 in the upper contour roller 220 by the angles α₁ and α₂ to the perpendicular (to the rotation axis P3, respectively, P5), which become increasingly larger toward the outside (in FIG. 2, α₁>α₂ applies). The result of this is that a movement of the nozzles 202 takes place when the contour rollers 220 or 320 are rotated, since each nozzle 202 is situated in a corresponding groove of the contour roller 220, respectively, 320 and is forcibly guided. Thus, when the contour roller rotates about the axis P3, respectively, P5, the nozzles shown in the configuration in FIG. 2 are displaced outwardly, depending on the angle of inclination of the plane of extension of the individual grooves 221, 222, 223, respectively, 321, 322, 323. Since the outer-lying grooves are more sharply inclined, the nozzles 202 situated therein are displaced further outwardly in the direction P1, respectively, P2. The displacement in the center of a contour roll is corresponding minimal or, at least in the case of nozzle 202, does not even take place.

A 180° rotation of the contour roller 220, 320 in the configuration from FIG. 2 leads to the position shown in FIG. 3. Whereas in FIG. 2 the nozzles 202 are spaced minimally apart next to one another, the spacing of the nozzles 202 in FIG. 3 is correspondingly maximal. This is due to the fact that each groove set in the axial direction P3, respectively, P5 rolls around the rotation axis P3, respectively, P5 during rotation of the corresponding contour roller 220, 320. As a result of this effect, the plane of extension of the grooves (depicted by the angles α₁ and α₂ to the perpendicular L in FIG. 2) migrates and assumes new angles perpendicular to the respective rotation axis, which are referred to in FIG. 3 by way of example of the upper contour roller 220 by ß₁ and ß₂, wherein here again ßᵢ>ß₂ is applicable.

In this way, it is possible, depending on the angle setting, i.e., the rotational position of the contour rollers 220, 320, to vary the spacings between the nozzles 202 as desired, which may be adjusted by a corresponding machine control. Thus, it is possible to set the machine control of a winding device, in particular, of a wave winding device, in such a way that the spacing of the nozzles 202 is reduced or increased—in particular, continuously, during the course of the process.

1. A wire outlet nozzle arrangement (200), comprising a plurality of wire outlet nozzles (202) situated in parallel with one another, each of which guides a winding wire (201) in a wire feed device (X), wherein the wire outlet nozzles (202) include an outlet opening, through which the winding wire (201) guided in the wire outlet nozzle exits the respective wire outlet nozzle (202),
wherein
the wire outlet nozzles (202) are mounted so as to be at least partially movable in a direction (P1, P2) perpendicular to the wire feed direction (X).

2. The wire outlet nozzle arrangement (200) according to claim 1, further comprising
a locking arrangement for fixing the wire outlet nozzles (102) in a moving position.

3. The wire outlet nozzle arrangement (200) according to claim 1,
wherein
the outlet openings of the wire outlet nozzles (202) have a rectangular cross section, wherein the winding wire (201) also has a rectangular cross section.

4. The wire outlet nozzle arrangement (200) according to claim 1,
further comprising
at least one contour roller (220, 230) mounted so as to rotate about an axis (P3; P4) perpendicular to the wire feed direction (X), wherein the contour roller (220; 230) comprises a plurality of recesses (221-223; 231-233) engaging, in particular, positively, with the outsides of the wire outlet nozzles (202).

5. The wire outlet nozzle arrangement (200) according to claim 4,
wherein
the recesses (221-223; 231-233) are closed grooves encircling the at least one contour roller (220; 230), each of which has a plane of extension defined by its respective direction of extension, wherein the angles of inclination of the planes of extension of the grooves defined by the perpendicular to the respective rotation axis of the contour roller are selected so that the angles of inclination of the grooves become greater from the center of the contour roller (220; 230) outward toward both ends of the contour roller (220; 230).

6. The wire outlet nozzle arrangement (200) according to claim 4,
further comprising
a drive unit (240), which drives the contour rollers (220; 230) in a rotational manner.

7. The wire outlet nozzle arrangement (200) according to claim 6,
wherein
the drive unit (240) is self-locking, so that the control rollers (220; 230) are lockable in any position.

8. A wire winding device, comprising a wire outlet nozzle arrangement (200) comprising a plurality of wire outlet nozzles (202) situated in parallel with one another, each of which guides a winding wire (201) in a wire feed device (X), wherein the wire outlet nozzles (202) include an outlet opening, through which the winding wire (201) guided in the wire outlet nozzle exits the respective wire outlet nozzle (202), wherein the wire outlet nozzles (202) are mounted so as to be at least partially movable in a direction (P1, P2) perpendicular to the wire feed direction (X).

9. The wire winding device according to claim 8, wherein the wire outlet nozzle arrangement (200) further comprises
a locking arrangement for fixing the wire outlet nozzles (102) in a moving position.

10. The wire winding device according to claim 8,
wherein
the outlet openings of the wire outlet nozzles (202) have a rectangular cross section, wherein the winding wire (201) also has a rectangular cross section.

11. The wire winding device according to claim 8, wherein the wire outlet nozzle arrangement (200),
further comprises
at least one contour roller (220, 230) mounted so as to rotate about an axis (P3; P4) perpendicular to the wire feed direction (X), wherein the contour roller (220; 230) comprises a plurality of recesses (221-223; 231-233) engaging, in particular, positively, with the outsides of the wire outlet nozzles (202).

12. The wire winding device according to claim 11,
wherein
the recesses (221-223; 231-233) are closed grooves encircling the at least one contour roller (220; 230), each of which has a plane of extension defined by its respective direction of extension, wherein the angles of inclination of the planes of extension of the grooves defined by the perpendicular to the respective rotation axis of the contour roller are selected so that the angles of inclination of the grooves become greater from the center of the contour roller (220; 230) outward toward both ends of the contour roller (220; 230).

13. The wire winding device according to claim 11, wherein the wire outlet nozzle arrangement (200),
further comprises
a drive unit (240), which drives the contour rollers (220; 230) in a rotational manner.

14. The wire winding device according to claim 13, wherein
the drive unit (240) is self-locking, so that the control rollers (220; 230) are lockable in any position.
